(19) United States
(12) Patent Application Publication
(10) Pub. No.: US 2011/0004608 A1
(43) Pub. Date: Jan. 6, 2011

(54) COMBINING AND RE-RANKING SEARCH RESULTS FROM MULTIPLE SOURCES

(75) Inventors: John Solaro, Bellevue, WA (US); Jim Gooder, Port Orchard, WA (US); Alex Semko, Bellevue, WA (US); Sumved Sharma, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/497,163

(22) Filed: Jul. 2, 2009

(51) Int. Cl. G06F 17/30

(52) U.S. Cl. 707/759; 707/769; 707/770

(57) ABSTRACT

Embodiments are presented for combining and re-ranking results of the same search performed by multiple search sources. This is generally accomplished by first inputting the results of the search from the multiple sources. Typically the results produced by the sources and their rankings will vary from one source to another. A ranking standard is established based on the differences in rank between consecutively ranked search results items in the results input from one of the search sources that is designated as the primary search source. The search result items from each secondary search source are then re-ranked based on this ranking standard to create a common ranking scheme for all the search result items input from the primary and secondary search sources. In addition, duplicate search result items are eliminated. The remaining primary and secondary search result items are then provided to the user in a single results set.

### BACKGROUND

In a typical computer-implemented search setting, a user inputs what they want to find by typing search query terms into a query box. A search application associated with a search source performs the search by finding search result items such as Internet web sites, documents, and so on, which correspond to the search query terms. The discovered items are typically ranked according to their relevance to the search terms. To accomplish this ranking, search sources employ a variety of ranking programs, which are often their own proprietary schemes. The result is that a search performed by one search source will often produced different results than another search source, even though both use the same search query terms. In addition, when two different search sources identify the same search result item, it is sometimes ranked differently owing to the diverse ranking schemes employed.

### SUMMARY

Embodiments described herein for combining and re-ranking results of a search performed by multiple search sources involves inputting the results from two or more different search sources, applying a uniform ranking system to all the different result sets, and then combining and presenting the results to a user. In one general embodiment, combining and re-ranking results of the same search performed by multiple search sources is accomplished by first inputting the results of the search from the sources. The search results take the form of a list of search result items that have been ranked by the source that performed the search. While some of the search result items included by each search source may also be found in the search results produced by another source, generally the results produced by the sources will vary from one another. The rank of each search result item is based on its perceived relevance as determined using a ranking scheme employed by the search source. Re-ranking of the combined search results is based on the rankings of one of the search sources, which has been designated as the primary search source. The one or more other search sources are considered secondary search sources.

Once the search results have been input, a ranking standard is established based on the differences in rank between consecutively ranked search results items in the results input from the primary search source. The search result items from each secondary search source are then re-ranked based on this ranking standard to create a common ranking scheme for all the search result items input from the primary and secondary search sources. In addition, duplicate search result items are eliminated. The remaining primary and secondary search result items are then provided to the user.

It should also be noted that this Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

The specific features, aspects, and advantages of the disclosure will become better understood with regard to the following description, appended claims, and accompanying drawings where:

FIG. 1 is a diagram of a system environment for combining and re-ranking results of a search performed by multiple search sources.

FIG. 2 is a flow diagram generally outlining one embodiment of a process for combining and re-ranking results of a search performed by multiple search sources.

FIGS. 3A-B are a continuing flow diagram generally outlining an implementation of a part of the process of FIG. 2 involving the establishment of a ranking standard using the search results from the primary search source.

FIG. 4 is a flow diagram generally outlining an implementation of a part of the process of FIG. 2 involving the re-ranking of the search result items from a secondary search source using the ranking standard.

FIG. 5 is a flow diagram generally outlining an implementation of a part of the process of FIG. 2 involving the elimination of duplicate search result items.

FIG. 6 is a flow diagram generally outlining an implementation of a part of the process of FIG. 2 involving providing the re-ranked search result items remaining from those input from the primary and secondary search sources to the user.

FIG. 7 is a diagram depicting a general purpose computing device constituting an exemplary system for implementing search results combining technique embodiments described herein.

### DETAILED DESCRIPTION

In the following description of search results combining technique embodiments reference is made to the accompanying drawings which form a part hereof, and in which are shown, by way of illustration, specific embodiments in which the technique may be practiced. It is understood that other embodiments may be utilized and structural changes may be made without departing from the scope of the technique.

### 1.0 Re-Ranking Combined Search Results

In general, the re-ranking of combined search results involves inputting the results from two or more different search sources, applying a uniform ranking system to all the different result sets, and then combining, de-duping, and presenting the results to a user.

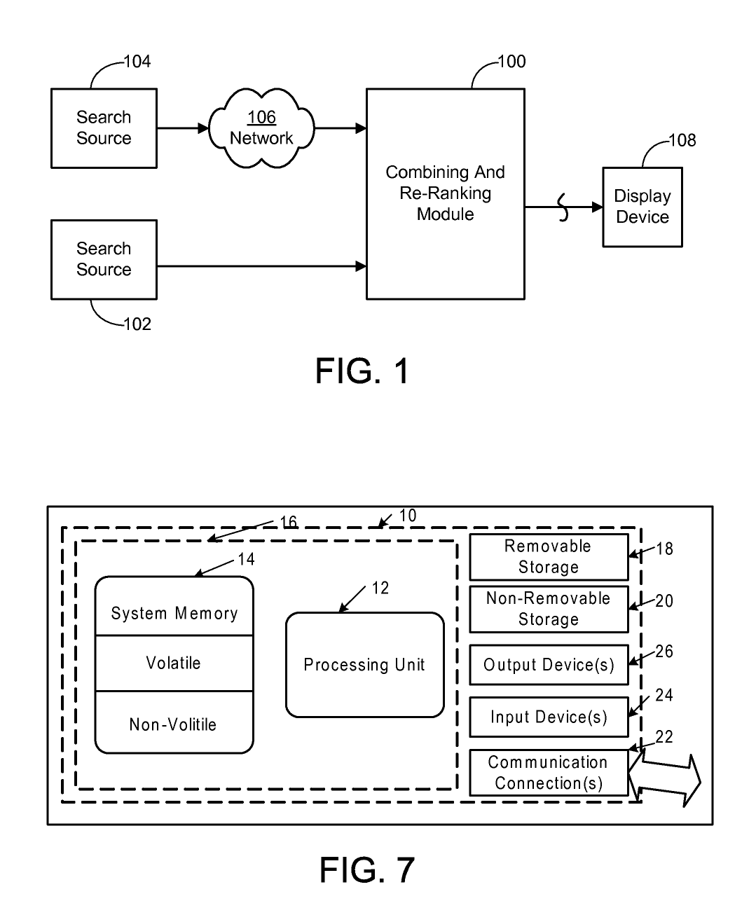

Before exemplary embodiments for combining and re-ranking results of a search performed by multiple search sources (hereinafter referred to as search results combining technique embodiments) are described, a general description of a suitable system environment in which portions thereof may be implemented will be described. Referring to FIG. 1, the combining and re-ranking of multiple search results is handled by a combining and re-ranking module 100. The combining and re-ranking module 100 is running on a computing device such as those described in the computing environment section presented later in this disclosure. The different sets of search results are input to the computing device 100 from multiple different search sources (two of which are shown) 102, 104. The search sources can be local (as shown by source 102 in FIG. 1) in that they feed the search results directly to the combining and re-ranking module 100. The local search sources may even be running on the same computing device as the combining and re-ranking module 100. Alternately, the search sources can be remote and their search results provided to the combining and re-ranking module 100 via a computer network 106 (as shown by source 104 in FIG. 1), such as the Internet or a proprietary intranet. The combined and re-ranked search results are provided to the user via a display device 108. The display device can also be local or remote. A local display device 108 would be associated with the computing device on which the combining and re-ranking module 100 is operating. A remote display device could be associated with a different computing device and the combined and re-ranked results sent via a network (not shown).

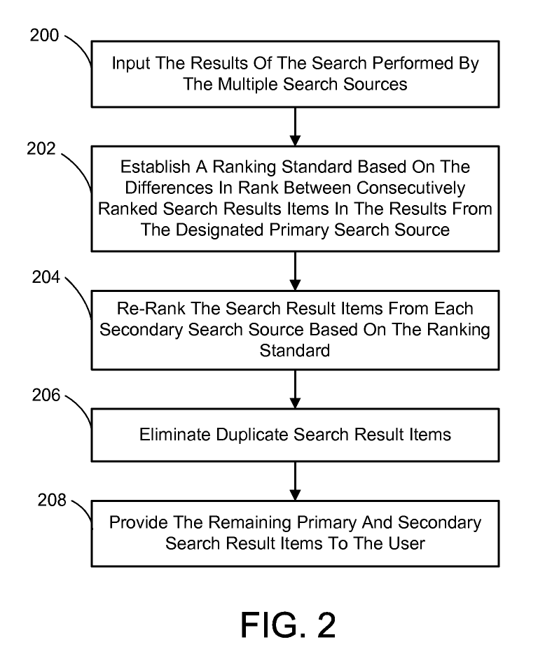

In one general embodiment, combining and re-ranking results of a search performed by multiple search sources is accomplished as shown in the process flow diagram of FIG. 2. First, the results of the search performed by the multiple search sources is input into a computing device (200). The same search is performed by each of the search sources. For example, each search source might use the same search query terms to perform the search. The search results take the form of a list of search result items that have been ranked by the source that performed the search. While some of the search result items included by one search source may also be found in the search results produced by another source, generally the results produced by the sources will vary from one another. The rank of each search result item is based on its perceived relevance as determined using a ranking scheme employed by the search source. Typically, the ranking scheme employed by each search source will be different from the other sources. Accordingly, there is often little correlation between the search results and rankings produced by two different search sources. As will be described in more detail in the disclosure to follow, re-ranking of the combined search results is generally based on the rankings of one of the search sources. As such, the search sources include a designated primary search source, and one or more secondary search sources. This primary search source can be a default source that is automatically selected as the primary source, or a user initiating the combined search can select which source is to be the primary source. It is noted that the foregoing choice of the primary search source can occur before or after the search results are input. In one embodiment, the search source selected as the primary source is the source deemed to be the most reliable in producing accurate and useful search results.

Once the search results have been input, a ranking standard is then established based on the differences in rank between consecutively ranked search results items in the results from the primary search source (202). The search result items from each secondary search source are re-ranked based on this ranking standard to create a common ranking scheme for all the search result items input from both the primary and secondary search sources (204). In addition, duplicate search result items are eliminated (206). The remaining primary and secondary search result items are then provided to the user (208).

The foregoing actions will now be described in more detail in the sections to follow.

### 1.1 Establishing the Ranking Standard

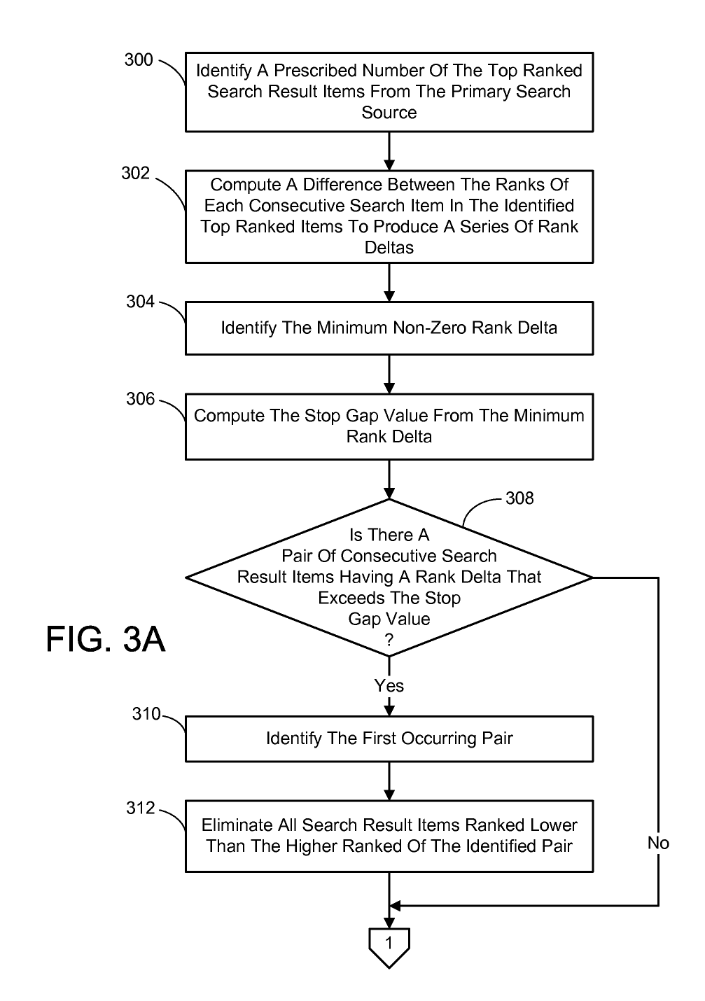

As disclosed previously, a ranking standard is established using the search results from the primary search source. Referring to FIGS. 3A-B, in one embodiment this entails first identifying a prescribed number of the top ranked search result items input from the primary search source (300). For example, the top ten ranking search result items can be identified. A difference between the ranks of each consecutive search item in the identified group is then computed to produce a series of rank deltas (302). For example, with the search results items arranged in a descending order according to their ranks, the difference between the ranks of the first and second items is computed to produce a first rank delta, the difference between the ranks of the second and third items is computed to produce a second rank delta, and so on. The minimum non-zero rank delta is then identified (304), and a so-called stop gap value is computed (306). In one embodiment, this stop gap value is computed as a prescribed multiple of the minimum rank delta. For example, the stop gap value can be four times the minimum rank delta.

It is next determined if a pair of consecutive search result items having a rank delta that exceeds the stop gap value exists in the search results input from the primary search source (308). This determination presumes the search result items are arranged in a descending order according to their ranks. If one or more such pairs exist, the first occurring pair is identified (310), and all result items ranked lower than the higher ranked of the identified pair are eliminated from the search results (312). After eliminating the lower ranked search result items, or if no pair was identified, an average rank delta is then computed from rank deltas computed between all the remaining consecutively-ranked search result items of the primary search source (314). This average rank delta is designated as the ranking standard (316).

It is noted that in a situation where the first occurring pair of consecutive search result items having a rank delta that exceeds the stop gap value involves the first two items in the rank-ordered search results, only the first search result item would be retained. In such a case, a prescribed default rank delta value is used as the average rank delta. For instance, in the absence of a calculated rank delta, the smallest rank unit of the ranking scheme employed by the primary search source can serve as the default rank delta. As an example, suppose the ranking scheme employed by the primary search source range from 1 to 64K, and is always a whole number. In such a case, a suitable value for the default rank delta is 1. Any other ranking system from a primary search source could be translated into an equivalent range. Also, default rank delta is configurable and should be set depending on the range of ranks used by the search sources.

It is also noted that the prescribed default rank delta value can be used in a situation where the remaining search result items from the primary search source all have the same rank. Thus, the prescribed default rank delta value is used instead of a zero average rank delta.

1.2 Re-Ranking the Search Result Items from the Secondary Sources

The search result items from each secondary search source are re-ranked using the aforementioned ranking standard to create a common ranking scheme for all the search result items from the primary and secondary search sources. This involves separately re-ranking the items from each secondary source as follows.

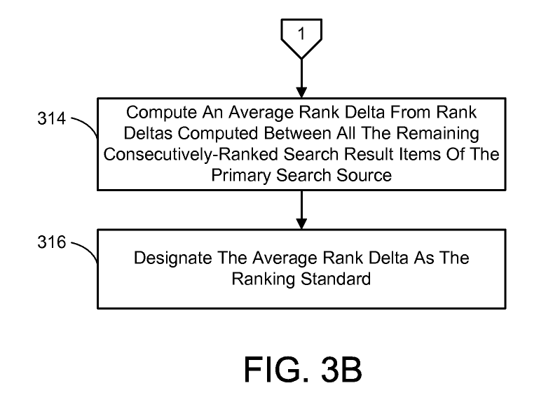

Referring to FIG. 4, in one embodiment, this re-ranking of a secondary source's search result items entails first identifying the highest ranked result item from the secondary search source under consideration (400). It is noted that in cases where a source can assign the same rank to more than one item, the highest ranked result can be the one listed first in the search results. The highest rank assigned to the search result items from the primary source is then assigned to the identified highest ranked result item from the secondary search source, in lieu of the rank assigned to the item by the secondary source (402). The next lower-ranked and previously unselected search result item from the secondary search source under consideration, starting with the second highest ranking search result item, is then selected (404). A rank that is equal to the rank of a next higher, newly-ranked search result item less the average rank delta is then assigned to the selected search result item (406). It is then determined if all the search result item from the secondary search source under consideration have been assigned a new rank (408). If not, actions 404 through 408 are repeated. Otherwise this part of the re-ranking procedure ends.

It is noted that in one embodiment of the re-ranking procedure, where the secondary source under consideration can assign the same rank to more than one item, all the search result items having the same initial rank are re-ranked with the same newly assigned rank. Thus, when the first of a series of items having the same initial rank is re-ranked with a certain value, the others having that same initial rank are also re-ranked with that same value.

It is further noted that in one embodiment of the re-ranking procedure, it is possible that not all the search result items from a secondary source will be re-ranked. In this embodiment, before the re-ranking occurs, all but a prescribed number (e.g., 10) of the highest ranked search result items from the secondary search source under consideration are eliminated. Thus, if the number of search result items from the secondary search source under consideration exceeds the prescribed number, some items are eliminated rather than being re-ranked.

### 1.3 Eliminating Duplicate Search Result Items

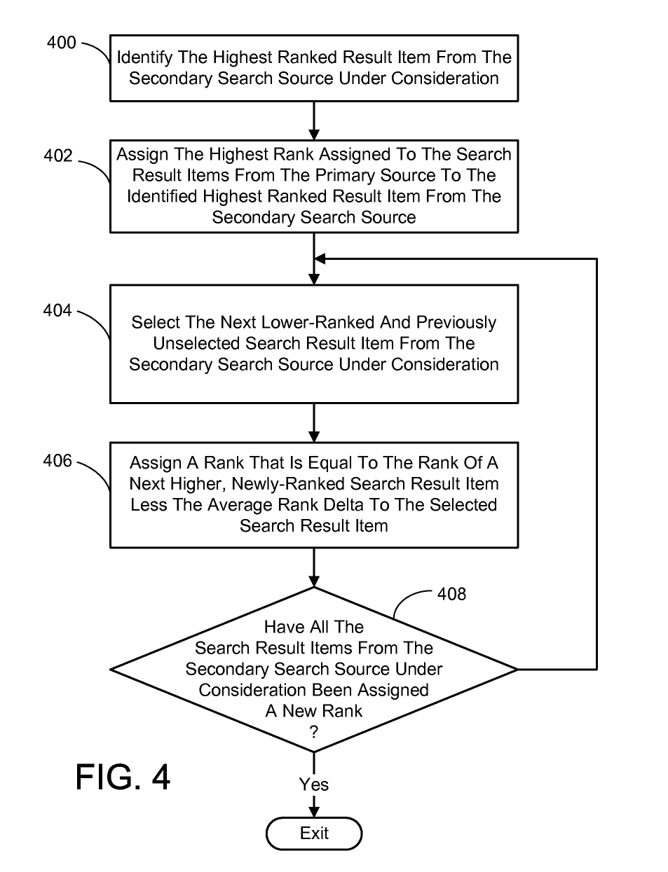

As disclosed previously, duplicate search result items among the search result items from the primary and secondary search sources are eliminated. Referring to FIG. 5, in one embodiment this is accomplished as follows. First, duplicate search result items from among the search results input from the primary and secondary search sources are identified (500). Any appropriate method can be employed to determine if a search result item is a duplicate of one of more other items. For instance, an appropriate method for finding a duplicate search result item is by comparing URLs associated with the results. The case of the URLs would be ignored in the comparison, as would be any ending forward slash. If two or more search result items are found to have identical URLs associated with them, then they are considered duplicate a duplicate item set.

The result of the identification action is to identify duplicate item sets each having two or more duplicate search result items. A previously unselected set is selected (502), and the highest ranking item in the set is identified (504). Next, all but the identified highest ranking search result item in the selected set are eliminated (506).

Optionally, when the lower ranking search result items in a set of duplicate items are eliminated, the rank of the remaining item can be increased. This recognizes the fact that more than one search source found the item relevant. To this end, the rank of the remaining search result item in each former set of duplicate search result items is increased by a prescribed amount (508). For example, the rank can be increased by two times the average rank delta. It is noted that the optional nature of this last action is indicated in FIG. 5 by the use of a broken line box.

It is next determined if all the identified duplicate item sets have been selected (510). If not, process actions 502 through 510 are repeated. Otherwise the procedure ends.

### 1.4 Adjusting the Assigned Rankings

The ranks assigned to individual search result items can also be optionally adjusted under certain circumstances. More particularly, the rank of a search result item from the primary source, or the newly-assigned rank of an item from a secondary source, can be increased or decreased based on circumstances indicative of an item's relevance.

For example, in one embodiment, each search result item is inspected to determine if a search term used in the search producing the item is found in both a body of the item and in metadata associated with the item. If so, the rank of the search result item is increased by a prescribed amount (e.g., two times the average rank delta).

Further, in one embodiment, each search result item is inspected to determine if a search term used in the search producing the item is found only in metadata associated with the item. If so, the rank of the search result item is decreased by a prescribed amount (e.g., two times the average rank delta).

### 1.5 Culling “Blacklisted” Search Result Items

Another optional procedure involves eliminating search result items that are deemed to be unacceptable based on a prescribed acceptability criteria. This is sometimes referred to as culling “blacklisted” items. For example, a list of previously determined unacceptable items can be loaded into cache of the search application from a specified source (e.g. a dedicated table in a database). The search result items can then be checked against that list and extracted. Blacklisted domains can either be identified by: content managers that find unacceptable results by conducting searches; users that report bad site results; or they can be managed by companies that produce lists of bad sites and provide updates on a periodic basis. These can be manually entered into a database table. Unwanted search result items can be culled from the search results produced by the primary or secondary search sources, or both. In addition, this culling can occur when the search results are input, before any processing, or once the processing is complete. Thus, in this latter case the search result items would not be culled until after the re-ranking, duplicate elimination and any optional rank adjustments have been made. As there will be fewer items to screen, doing the culling after the processing has the advantage of reducing the screening costs. However, doing the culling before processing means that fewer items will need to be processed, thereby saving on the processing costs.

### 1.6 Providing the Search Result Items to the User

The re-ranked and possibly rank-adjusted search result items remaining from those input from the primary and secondary search sources are provided to the user. Generally, this entails displaying the search result items.

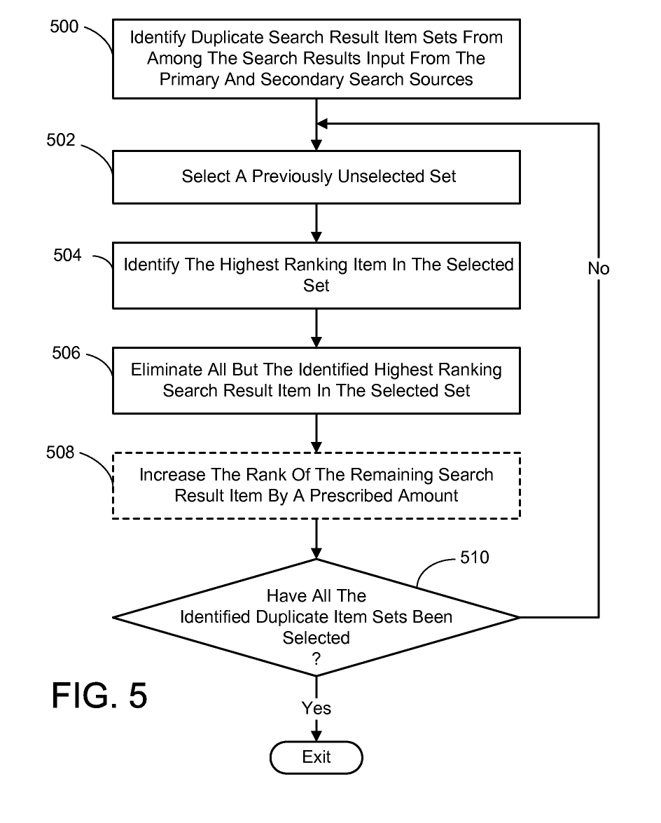

More particularly, referring to FIG. 6, in one embodiment this is accomplished as follows. First, the remaining primary and secondary search result items are ordered in descending order based on their assigned ranks (600). It is then determined if all of the previously un-displayed search results items will fit in a display space allocated on the display device for displaying the search result items (602). If they will, the search results items are displayed in descending order (604), and the procedure ends. However, if not all the search result items will fit, the lower-ranked items that will not fit in the display space are cached (606), and the search results items that will fit in the display space on the display device are displayed in descending order (608). The user inputs are monitored for a next page command (610) and it is periodically determined if the command is entered (612). Upon entry of the next page command, actions 602 through 612 are repeated for the currently cached search result items. Otherwise, the monitoring continues.

### 2.0 The Computing Environment

A brief, general description of a suitable computing environment in which portions of the search results combining technique embodiments described herein may be implemented will now be described. The technique embodiments are operational with numerous general purpose or special purpose computing system environments or configurations. Examples of well known computing systems, environments, and/or configurations that may be suitable include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

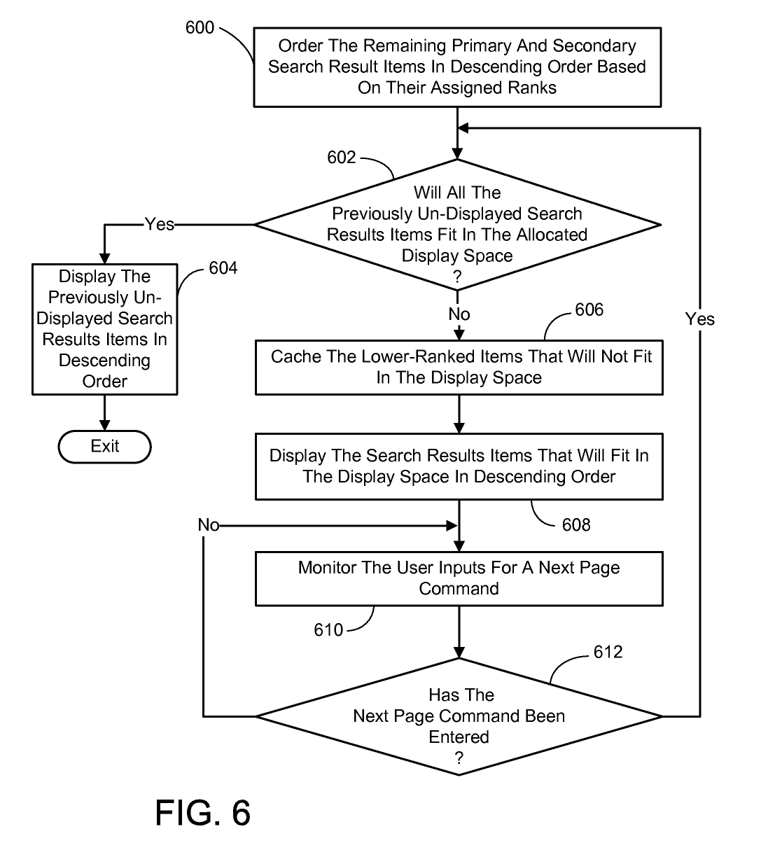

FIG. 7 illustrates an example of a suitable computing system environment. The computing system environment is only one example of a suitable computing environment and is not intended to suggest any limitation as to the scope of use or functionality of search results combining technique embodiments described herein. Neither should the computing environment be interpreted as having any dependency or requirement relating to any one or combination of components illustrated in the exemplary operating environment. With reference to FIG. 7, an exemplary system for implementing the embodiments described herein includes a computing device, such as computing device 10. In its most basic configuration, computing device 10 typically includes at least one processing unit 12 and memory 14. Depending on the exact configuration and type of computing device, memory 14 may be volatile (such as RAM), non-volatile (such as ROM, flash memory, etc.) or some combination of the two. This most basic configuration is illustrated in FIG. 7 by dashed line 16. Additionally, device 10 may also have additional features/functionality. For example, device 10 may also include additional storage (removable and/or non-removable) including, but not limited to, magnetic or optical disks or tape. Such additional storage is illustrated in FIG. 7 by removable storage 18 and non-removable storage 20. Computer storage media includes volatile and nonvolatile, removable and non-removable media implemented in any method or technology for storage of information such as computer readable instructions, data structures, program modules or other data. Memory 14, removable storage 18 and non-removable storage 20 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 10. Any such computer storage media may be part of device 10.

Device 10 may also contain communications connection(s) 22 that allow the device to communicate with other devices. Device 10 may also have input device(s) 24 such as keyboard, mouse, pen, voice input device, touch input device, camera, etc. Output device(s) 26 such as a display, speakers, printer, etc. may also be included. All these devices are well know in the art and need not be discussed at length here.

The search results combining technique embodiments described herein may be further described in the general context of computer-executable instructions, such as program modules, being executed by a computing device. Generally, program modules include routines, programs, objects, components, data structures, etc. that perform particular tasks or implement particular abstract data types. The embodiments described herein may also be practiced in distributed computing environments where tasks are performed by remote processing devices that are linked through a communications network. In a distributed computing environment, program modules may be located in both local and remote computer storage media including memory storage devices.

### 3.0 Other Embodiments

It is noted that any or all of the aforementioned embodiments throughout the description may be used in any combination desired to form additional hybrid embodiments. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Wherefore, what is claimed is:

1. A computer-implemented process for combining and re-ranking results of a search performed by multiple search sources, comprising:
using a computer to perform the following process actions:
inputting the results of said search performed by multiple search sources, wherein said results from each search source comprise ranked search result items, and wherein the search sources comprise a primary search source and one or more secondary search sources;
establishing a ranking standard based on the differences in rank between consecutively ranked search results items in the results inputted from the primary search source;
re-ranking the search result items inputted from each secondary search source based on the established ranking standard to create a common ranking scheme for all the search result items input from the primary and secondary search sources;
eliminating duplicate search result items among the search result items input from both the primary and secondary search sources; and
providing the remaining primary and secondary search result items to a user.

2. The process of claim 1, wherein the process action of inputting the results of said search performed by multiple search sources, comprises an action of inputting the results of said search performed by multiple search sources using the same search terms.

3. The process of claim 1, wherein the process action of inputting the results of said search performed by multiple search sources, comprises an action of selecting one of the search sources as the primary search source.

4. The process of claim 1, wherein the process action of inputting the results of said search performed by multiple search sources, comprises an action of culling search result items that are deemed to be unacceptable based on a prescribed acceptability criteria.

5. The process of claim 1, wherein the process action of establishing the ranking standard, comprises the actions of:
identifying a prescribed number of the top ranked search result items input from the primary search source;
computing a difference between the ranks of each consecutive search item in the prescribed number of top ranked results to produce a series of rank deltas;
identifying a minimum rank delta;
computing a stop gap value, wherein the stop gap value comprises a prescribed multiple of the minimum rank delta;
identifying a pair of consecutively ranked search result items in the search results input from the primary search source considered in a descending rank order that have a rank delta that exceeds the stop gap value, if any;
whenever one or more pairs of consecutively ranked search result items in the search results input from the primary search source considered in a descending rank order are found to have a rank delta that exceeds the stop gap value, eliminating all result items ranked lower than the higher ranked of the first-identified pair of consecutively ranked search results items having a rank delta that exceeds the stop gap;
computing the average rank delta from the rank deltas computed between all the remaining consecutively-ranked search result items; and
designating the average rank delta to be said ranking standard.

6. The process of claim 5, wherein the prescribed number of the top ranked search result items input from the primary search source is ten items.

7. The process of claim 5, wherein the stop gap value is 4 times the minimum rank delta.

8. The process of claim 5, wherein there is only one search result item remaining after eliminating all result items ranked lower than the higher ranked of the identified pair of consecutively ranked search results items having a rank delta that exceeds the stop gap, and wherein the process action of computing the average rank delta comprises establishing a prescribed default rank delta value as the average rank delta.

9. The process of claim 5, wherein the process action of re-ranking the search result items inputted from each secondary search source based on the established ranking standard, comprises the actions of:
for each secondary search source,
identifying a highest ranked secondary result item input from the secondary search source under consideration,
assigning the rank of a highest ranked primary search result item to the highest ranked secondary search result item,
for each search result item input from the secondary search source under consideration that is ranked below the top ranked item input from that source starting with a second highest ranking search result item, assigning a rank that is equal to the rank of a next higher ranked search result item less the average rank delta.

10. The process of claim 9, wherein the process action of re-ranking the search result items inputted from each secondary search source further comprises, prior to performing the process action assigning a rank that is equal to the rank of a next higher ranked search result item less the average rank delta to each search result item input from the secondary search source under consideration that is ranked below the top ranked item, a process action of eliminating all but a prescribed number of the highest ranked search result items input from the secondary search source under consideration.

11. The process of claim 10, wherein the prescribed number of the highest ranked search result items input from the secondary search source under consideration is ten items.

12. The process of claim 9, wherein the process action of eliminating duplicate search result items among the search result items input from both the primary and secondary search sources, comprises the actions of:
identifying duplicate search result items from among the search results input from the primary and secondary search sources; and
for each set of duplicate search results found, eliminating all but the highest ranking one.

13. The process of claim 12, further comprising an action of increasing the rank of the remaining search result item in each set of duplicate search result items by a prescribed amount.

14. The process of claim 9, further comprising the actions of:
for each search result item,
determining if a search term used in producing the inputted search results is found in both a body of a search result item and metadata associated with the search result item; and
whenever it is determined that a search term used in producing the inputted search results is found in both a body of the search result item and metadata associated with the search result item, increasing the rank of the search result item by a prescribed amount.

15. The process of claim 9, further comprising the actions of:
for each search result item,
determining if a search term used in producing the inputted search results is found only in metadata associated with the search result item; and
whenever it is determined that a search term used in producing the inputted search results is found only in metadata associated with the search result item, decreasing the rank of the search result item by a prescribed amount.

16. The process of claim 9, further comprising a process action of eliminating search result items among the search result items input from both the primary and secondary search sources that are deemed to be unacceptable based on a prescribed acceptability criteria.

17. The process of claim 1, wherein the process action of providing the remaining primary and secondary search result items to a user, comprises the actions of:
(a) ordering the remaining primary and secondary search result items in a descending order of their assigned ranks;
(b) determining if all of the search results items will fit in a display space on a display device whenever displayed in descending order;
(c) whenever it is determined that all of the search results items will not fit in a display space, caching all the search results items that will not fit in the display space;
(d) displaying all the search results items that will fit in the display space on the display device in descending order; and
(e) upon entry of a next page command by the user, repeating actions (b) through (d) for the currently cached search result items.

18. A system for combining and re-ranking results of a search performed by multiple search sources, comprising:
a general purpose computing device having a display; and
a computer program comprising program modules executed by the computing device, wherein the computing device is directed by the program modules of the computer program to,
input the results of the search performed by multiple search sources, wherein said results from each search source comprise ranked search result items, and wherein the search sources comprise a primary search source and one or more secondary search sources,
establish a ranking standard based on the differences in rank between consecutively ranked search results items in the results inputted from the primary search source,
re-rank the search result items inputted from each secondary search source based on the established ranking standard,
eliminate duplicate search result items among the search result items input from both the primary and secondary search sources, and
display the remaining primary and secondary search result items on said display.

19. A computer-readable storage medium having computer-executable instructions stored thereon for combining and re-ranking results of a search performed by multiple search sources, said computer-executable instructions comprising:
inputting the results of said search performed by multiple search sources, wherein said results from each search source comprise ranked search result items which can include items having the same rank, and wherein the search sources comprise a primary search source and one or more secondary search sources;
identifying a prescribed number of the top ranked search result items input from the primary search source;
computing a difference between the ranks of each consecutive search item in the prescribed number of top ranked results to produce a series of rank deltas;
identifying the minimum non-zero rank delta;
computing a stop gap value, wherein the stop gap value comprises a prescribed multiple of the minimum non-zero rank delta;
identifying a first occurring pair of consecutively ranked search result items considered in a descending rank order that have a rank delta that exceeds the stop gap value, if any;
whenever a first occurring pair of consecutively ranked search result items considered in a descending rank order is found to have a rank delta that exceeds the stop gap value, eliminating all result items ranked lower than the higher ranked of the identified pair of consecutively ranked search results items having a rank delta that exceeds the stop gap;
computing the average rank delta from the rank deltas computed between all the remaining consecutively-ranked search result items;
for each secondary search source,
identifying a highest ranked secondary result item input from the secondary search source under consideration,
assigning the rank of a highest ranked primary search result item to each of the secondary search result items having the highest rank as assigned by the secondary search source under consideration, and
for each search result item input from the secondary search source under consideration that is ranked below the top ranked item input from that source starting with a second highest ranking search result item, assigning a rank that is equal to the rank of a next higher ranked search result item less the average rank delta;
identifying duplicate search result items from among remaining search results input from the primary and secondary search sources;
for each set of duplicate search results found, eliminating all but the highest ranking one; and
providing the primary and secondary search result items remaining to a user.

20. The computer-readable storage medium of claim 19, further comprising an instruction for increasing the rank of the remaining search result item in each set of duplicate search result items by a prescribed amount.
